(19) United States
(12) Patent Application Publication
(10) Pub. No.: US 2026/0008617 A1
(43) Pub. Date: Jan. 8, 2026

(54) AUTOMATED OVERHEAD FOLLOWER

(71) Applicant: Fives Inc., Farmington Hills, MI (US)

(72) Inventors: John A. Lopetrone, Canton, MI (US); John Stencel, Milford, MI (US); Wade Rickard, Hartland, MI (US)

(73) Assignee: Fives Inc., Farmington Hills, MI (US)

(21) Appl. No.: 19/248,901

(22) Filed: Jun. 25, 2025

Related U.S. Application Data
(60) Provisional application No. 63/666,850, filed on Jul. 2, 2024.

(51) Int. Cl. B65G 1/137; B61B 3/02; B61C 13/04; G05D 1/244; G05D 107/70; G05D 109/10; G05D 111/20; G05D 111/30

(52) U.S. Cl. CPC B65G 1/1373; B61B 3/02; B61C 13/04; G05D 1/2446; B65G 2203/041; B65G 2203/046; B65G 2209/04; G05D 2107/70; G05D 2109/14; G05D 2111/20; G05D 2111/34

(57) ABSTRACT

An automated overhead follower (AOF) system for a picking process includes an overhead rail, a motorized trolley configured to engage the rail and translate along its longitudinal axis in response to position control signals, a light projector connected to the trolley that emits a light beam in response to lighting control signals, and a radio frequency (RF) transmitter connectable to a tray. An electronic control unit (ECU) receives three-dimensional (3D) position signals from the transmitter as the tray moves along a bin aisle, identifies a bin zone in the aisle using the 3D position signals, and transmits the position control signals to a motor to command the trolley to move to the identified bin zone. The ECU also transmits the lighting control signals to the projector to illuminate one of more bins in the identified bin zone.

### CROSS-REFERENCE TO RELATED APPLICATIONS

The present application claims the benefit of priority to U.S. Provisional Application No. 63/666,850 filed on Jul. 2, 2024, which is hereby incorporated by reference in its entirety.

### INTRODUCTION

The present disclosure pertains to control systems and methodologies for assisting an operator in the performance of a manual bin-picking process. In the context of manufacturing or order fulfilment/warehouse operations, “picking” entails locating particular storage bins, extracting one or more items stored therein, and transporting the extracted item(s) to a designated work area for kitting, assembly, or shipment. In a relatively simple manual workstation, for instance, an operator may be positioned at a table equipped with necessary assembly and/or packaging tools and one or more tiers of task-relevant storage bins. Using such a layout, the operator is able to access the required bins and perform a given work task with increased economy of motion. In contrast, larger warehouse-type operations often rely on a mobile picking process during which the operator is required to move along aisles of storage bins to locate and select required items from an associated pick list.

### SUMMARY

A system and related method are described herein for use in a manual picking process. In particular, the solutions described herein employ automated tracking functions and light-based information to facilitate the picking process.

In a manual picking process as described herein, an operator in a large warehouse or other facility may be assisted by a motorized trolley that is suspended above the operator from an overhead rail and connected to a light projector. Motion of the trolley is controlled as a tray and cart are moved along a bin aisle, e.g., carried by the operator or moved via a roller conveyor or an automated conveyor belt. The tray supports the cart, for instance an open-sided box for transporting picked items within the facility. The tray or cart is coupled to a radio frequency (RF) signal transmitting device (“RF transmitter”). The RF transmitter for its part communicates or broadcasts its position to an electronic control unit (ECU) in its proximity, for example as nominal Cartesian X, Y, and Z axis position coordinates. As the RF transmitter is mounted to the tray (and/or cart) as set forth herein, the transmitted position data from the RF transmitter is treated by the ECU as being the three-dimensional position of the tray (“3D tray position”) in free space, i.e., within the facility. The trolley is connected to and propelled along the overhead rail by an electric motor or other suitable linear or rotary actuator, the position of which on the overhead rail is determined and tracked in real time by the ECU.

The ECU uses the reported 3D tray position to control at least two operations of the motorized trolley: (1) the overhead position of the trolley relative to the tray/cart, and (2) an output state of the projector. In a possible implementation, the ECU monitors the 3D tray position relative to bin zones as the tray is moved through or along a given bin aisle. As the tray enters a designated bin zone, the ECU commands the electric motor to move the trolley into the same bin zone, for instance directly overhead of/above the tray or at a predetermined projection angle relative thereto. The ECU then commands the light projector to illuminate portions of one or more storage bins in the designated bin zone with information that instructs the operator, at a minimum, as to which bins to access during the manual picking process.

Aspects of the present disclosure pertain to an automated overhead follower (AOF) system for use in the manual picking process. The AOF system may include an overhead rail and a motorized trolley. The motorized trolley is configured to engage the overhead rail and translate along a longitudinal axis of the overhead rail in response to receipt of position control signals from the ECU. A light projector that is connected to the trolley emits a light beam in response to receipt of lighting control signals from the ECU. The RF transmitter used as part of the AOF system is connectable to a component tray and/or cart transported thereon.

In this example embodiment, the ECU is programmed to receive 3D position signals from the RF transmitter as the component tray/cart moves along a designed bin aisle, and to identify a bin zone (“identified bin zone”) of the designated bin aisle using the 3D position signals. The ECU is also programmed to transmit the position control signals to the electric motor to cause the motor to move the trolley toward/into the identified bin zone. The ECU communicates the lighting control signals to the light projector to cause the light projector to illuminate one of more bins in the identified bin zone, as “illuminated bins”, such that the illuminated bins reflect or otherwise present information to the operator.

A method is also disclosed herein for performing a manual picking process. An embodiment of the method includes receiving, via an ECU, 3D position signals from an RF transmitter connected to a tray. This occurs as the tray is moved along a designed bin aisle, with the 3D position signals being indicative of a 3D tray position of the tray. The method includes identifying a bin zone of a designed bin aisle using the 3D tray position as an identified bin zone, with the designated bin aisle being one of a plurality of bin aisles. Additionally, the method in this embodiment includes transmitting position control signals via the ECU to a motorized trolley to command the motorized trolley to move to the identified bin zone along an overhead rail. A light projector is connected to the motorized trolley. As part of the method, lighting control signals are also transmitted via the ECU to the light projector to cause the light projector to illuminate one of more bins in the identified bin zone. The illuminated bins thereby present information to the operator.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a perspective view illustration of an automated overhead follower (AOF) system in use with a representative bin aisle in accordance with one or more aspects of the present disclosure.

FIG. 2 is a schematic illustration of portions of the AOF system of FIG. 1 in accordance with an example implementation.

FIG. 3 is a schematic illustration of a manual picking process being performed with the assistance of the example AOF system of FIGS. 1 and 2.

FIG. 4 is a flow chart describing an embodiment of a method for using the AOF system of FIGS. 1-3 in a manual picking process.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

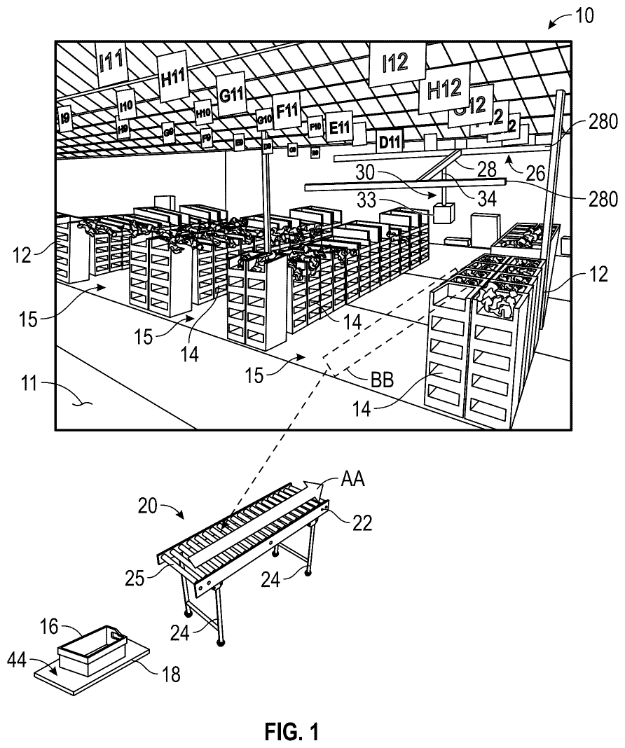

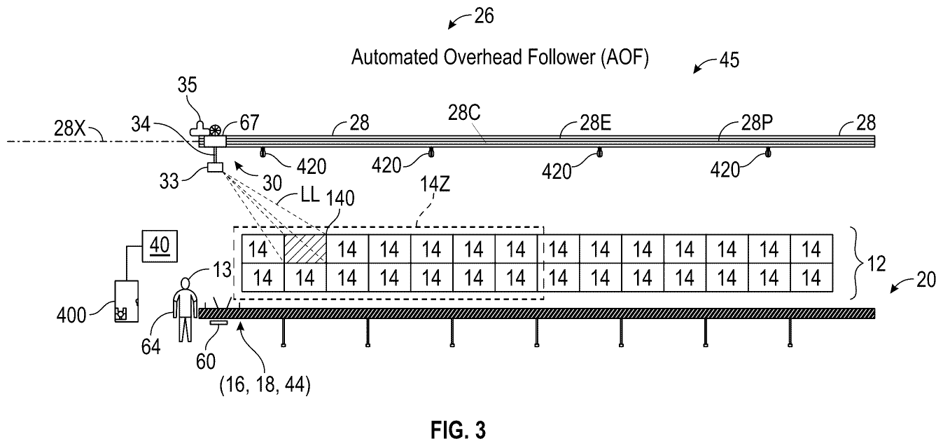

Referring to the drawings, wherein like reference numbers correspond to like or similar components throughout the several Figures, a warehouse 10 is illustrated in FIG. 1 that provides a working environment for performance of a manual picking process. In a logistical operation as contemplated herein, the term “picking” involves the process of selecting items from a warehouse's stock to fulfill an order, for instance a customer order, a bill of materials, or another packing list. In the simplified scenario of FIG. 1, for instance, a warehouse floor 11 may support various racks 12 of storage bins 14. The racks 12 may be arranged in multiple rows, with adjacent rows separated from each other by a bin aisle 15. Aisle space is therefore made available for an operator 13 (see FIG. 3) to move freely between the racks 12 when locating and selecting a particular component, product, or other item from a corresponding one of the storage bins 14.

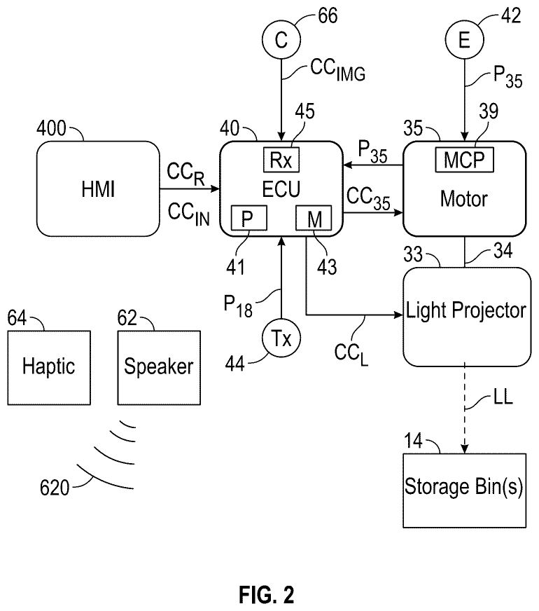

During a manual picking process, collected items are deposited by the operator 13 of FIG. 3 into a mobile cart 16 as the operator 13 moves through or along the various bin aisles 15. In some implementations, the cart 16 may be placed on or connected to a tray 18, for instance a rectangular plate constructed of plastic or metal. A radio frequency (RF) transmitter 44, e.g., an ultrasonic transmitter device, is connectable to the tray 18 (and/or the cart 16) and used as discussed below with reference to FIG. 2. The tray 18 for its part may be moved along a conveyor 20 in the direction of arrow AA to facilitate transportation of the cart 16 and collected items contained therein/thereon within the warehouse 10 of FIG. 1. While the cart 16 and the tray 18 are both used in the representative implementation of FIG. 1, the cart 16 or the tray 18 may be used alone in other applications and coupled to the RF transmitter 44. For illustrative consistency, the tray 18 will be described below as the carrier of the RF transmitter 44 without limiting applications to such a construction.

The conveyor 20 in the illustrated non-driven “roller conveyor” embodiment of FIG. 1 includes parallel conveyor rails 22 supported by a set of legs 24. The legs 24 in turn are securely supported by/mounted to the floor 11. A series of parallel rollers 25 are rotatably mounted to the conveyor rails 22 in a possible passive implementation. Thus, when the cart 16 and the tray 18 are moved in the direction of arrow AA, low-friction rotation of the rollers 25 minimizes the operator's required effort. One or more such conveyors 20 may be positioned in the bin aisles 15 in different layouts, with one such conveyor 20 arranged in designated conveyor area BB in the simplified layout of FIG. 1. Thus, the conveyor 20 when arranged along the designed bin aisle 15 enables the tray 18 to freely move on the rollers 25 while the operator 13 accesses the storage bins 14.

A manual picking process 45 (FIG. 3) conducted in the representative warehouse 10 of FIG. 1 is facilitated by use of an automated follower system (AOF) system 26 as described herein. In a possible construction, the AOF system 26 includes one or more overhead rails 28 having a respective longitudinal axis 28X (see FIG. 3). Each overhead rail 28 may be supported at either end by lateral rails 280 arranged orthogonally to the overhead rails 28, or by other stabilizing structure. A motorized trolley 30 is configured to engage the overhead rail 28 and translate along its length, i.e., along the longitudinal axis 28X. A light projector 33 is securely connected to the motorized trolley 30, e.g., via a bracket 34 or another suitable interconnecting member. As part of the present control strategy, the light projector 33 is automatically moved via operation of the motorized trolley 30 a position directly above (or at a predetermined projection angle to) the bin aisle 15 in response to movement of the mobile cart 16 and tray 18 located closer to the floor 11 below.

Referring to FIG. 2, coordination of motion of the motorized trolley 30 to position the light projector 33 as contemplated herein involves operation of an electronic control unit (ECU) 40 responsive to input signals CC_{IN} requesting assistance of the AOF system 26, and the wired and/or wireless communication of electronic signals within the warehouse 10 of FIG. 1. “Signal” as used herein may refer to any physically discernible indicator that conveys information. Communication of information may entail transmission of electrical signals via a conductive physical medium such as copper wires, electromagnetic signals (via air), optical signals (via optical waveguides), etc. Data signals may include discrete, analog or digitized analog signals representing inputs from sensors, actuator commands, and communication between controllers.

The ECU 40 of FIG. 1 may be configured as a microprocessor-based device having such common elements as the processor (P) 41, e.g., a microprocessor, central processing unit, processing logic, application specific integrated circuit (ASIC), etc., that executes one or more software or firmware programs to provide the described functionality. The ECU 40 also includes a non-transitory computer readable storage medium, hereinafter memory (M) 43. The memory 43 may include read-only memory (ROM) and other memory, e.g., random access memory (RAM), electrically-programmable read-only memory (EPROM), etc., and any required electronic circuitry, including but not limited to a high-speed clock (not shown), analog-to-digital (A/D) circuitry, digital-to-analog (D/A) circuitry, a digital signal processor, and the necessary input/output (I/O) devices and other signal conditioning and/or buffer circuitry. The ECU 40 also includes an RF receiver (Rx) 45 in communication with the RF transmitter (Tx) 44. In some implementations, the ECU 40 is in wired or wireless communication with a camera (C) 66 of the AOF system 26 to receive image data CC_{IMG} of the storage bins 14 output by the camera 66, for example when verifying accuracy of the bin picking process 45 illustrated in FIG. 3.

The ECU 40 of FIG. 2 may command motion of the motorized trolley 30 of FIG. 1 via position control signals CC₃₅. In response to the position control signals CC₃₅, e.g., pulse-width modulation (PWM) voltage signals, an electric motor 35 of the motorized trolley 30 (FIG. 1) is energized in a particular revolute direction. This action causes the motorized trolley 30 to travel along the overhead rail 28 of FIGS. 1 and 3, e.g., via splines or teeth (not show). The light projector 33 connected to the motorized trolley 30 is configured to emit a light beam LL, e.g., one or more laser beams or diffused light, in response to lighting control signals CC_{L} from the ECU 40. The direction, intensity, color, information content, and/or other properties of the light beam LL are commanded by the ECU 40 via the lighting control signals CC_{L}, with the light beam LL ultimately falling incident upon one or more of the above-noted storage bins 14.

With continued reference to FIG. 2, motor position information P₃₅ is communicated to the ECU 40 by a rotary encoder (E) 42 of the electric motor 35. In this manner, the ECU 40 is continuously or periodically informed of the present position of the electric motor 35 along the longitudinal axis 28X of the overhead rail 28 of FIGS. 1 and 3. The AOF system 26 of FIG. 1 is also equipped with the RF transmitter 44 as noted above, which in turn is in communication with the ECU 40 of FIG. 2. Using the RF transmitter 44, a three-dimensional position of the tray 18 (or the cart 16 when the tray 18 is not used) is measured in real-time and reported to the ECU 40. This measured and communicated position is referred to herein as the 3D tray position.

In accordance with the disclosure, the ECU 40 is programmed to receive 3D position signals P₁₈ from the RF transmitter 44 as the tray 18 moves along a designed bin aisle 15 (FIG. 1). The ECU 40 is also programmed to identify a bin zone 14Z (see FIG. 3) of the bin aisle 15 using the 3D position signals P₁₈, i.e., as an identified bin zone. The ECU 40 also transmits the motor control signals P₃₅ to the motorized trolley 30, or to a motor control processor (MCP) 39 of the electric motor 35 thereof, to command movement of the motorized trolley 30 into the identified bin zone.

Once this action is complete and the motorized trolley 30 has reached its commanded location, the ECU 40 transmits the lighting control signals CC_{L} to the light projector 33 to cause the light projector 33 to illuminate one of more of the storage bins 14 in the identified bin zone 14Z of FIG. 3. The resulting illuminated storage bins 140 presents information to the operator 13, e.g., via reflected light. Light-based information may be augmented in one or more implementations by audible and/or tactile information as noted below with reference to FIG. 3, for instance in response to a user request signal CC_{R} from a human-machine interface (HMI) 400, for example a control pad, smartphone, or tablet, desktop, or laptop computer. Thus, the operator 13 of FIG. 3 need not look directly at the storage bins 14 to perceive the required information, which may facilitate adoption by distracted or visually impaired operators 13.

Referring briefly to FIG. 3, the manual picking process 45 is illustrated while being performed with the assistance of the AOF system 26. The operator 13 is shown moving the cart 16 and the tray 18, with the RF transmitter 44 connected to one or the other, along the conveyor 20. An optional inductive charger 60 may be connected to or formed integrally with the tray 18 to maintain a desired state of charge of the RF transmitter 44. The overhead rail 28 is located above and extends parallel to the conveyor 20, with the motorized trolley 30 suspended from the overhead rail 28. The overhead rail 28 in one or more embodiments may include an electric circuit 28P configured to transfer power to the motorized trolley 30. The electric circuit 28P may also include, e.g., a high-speed communication bus 28C and an optional encoder strip 28E operable for precisely determining the current position of the electric motor 35 along the length of the overhead rail 28.

As the operator 13 pushes the tray 18 along the conveyor 20 in this non-limiting exemplary embodiment, the RF transmitter 44 communicates with the ECU 40 wireless and/or via physical transfer conductors. In response, the ECU 40 commands motion of the motorized trolley 30 via the electric motor 35 to a position above the relevant storage bin(s) 15, i.e., a specific one or more of the storage bins 15 corresponding to an item in a pick list. When a storage bin 15 contains an item from the pick list, the light projector 33 is commanded via the lighting control signals CCL of FIG. 2 to illuminate the storage bin 15 with the light beam LL.

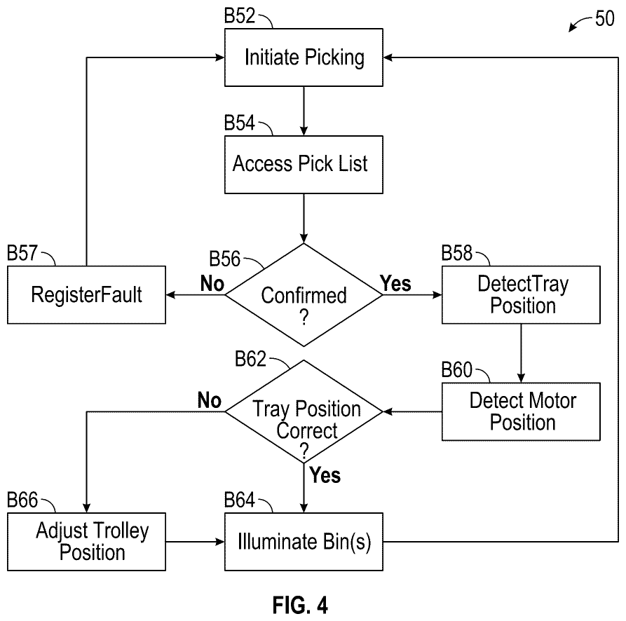

As noted above, the illuminated bin(s) 140 present information to the operator 13. For instance, information presented by the light beam LL informs the operator 13 as to a correct item in a picking sequence or order. When creating an example kit using components or items from the various storage bins 14, the ECU 40 of FIG. 2 may illuminate the storage bin or bins 14 containing such items. A calibrated picking sequence may be programmed into memory 43 of the ECU 40 and accessed by the processor 41 in executing a method 50 shown in FIG. 4, or embodiments thereof. The camera 66 noted above with reference to FIG. 2 may be optionally connected to the motorized trolley 30 and configured to output the image data CC_{IMG} of at least the illuminated storage bins 140. In such an implementation, the ECU 40 may be programmed to verify accuracy of the information using the image data CC_{IMG}, e.g., using machine vision software.

The motorized trolley 30 illustrated in FIG. 3 may include a carrier 67 that rides on the overhead rail 28. For instance, the carrier 67 may be implemented as a toothed or splined box that at least partially surrounds the overhead rail 28 and possibly houses the MCP 39 therewithin. Other components may be carried by or housed within the carrier 67, including an optical encoder, a variable-frequency drive (VFD) unit, a servo control circuit, etc. In a possible embodiment, the electric motor 35 may use a friction wheel to drive the carrier 67 along the length of the overhead rail 28. While the length of the overhead rail 28 may vary with the application, extended lengths of about 90-100 meters or more are common in large warehouse environments. Such extended lengths, coupled with the relatively inaccessible overhead location of the electric motor 35, calls for a sufficiently robust construction of the electric motor 35 to minimize the need for maintenance.

The ECU 40 of FIGS. 2 and 3 in one or more embodiments may be configured to detect when the operator 13 has accessed a storage bin 14, for instance using a light curtain approach. An exemplary light curtain-based solution is described in U.S. Pat. No. 9,372,278B2, which issued on Jun. 21, 2016, and which is hereby incorporated by reference in its entirety. For example, a curtain of visible or invisible light may be projected in a plane located between the operator 13 and the storage bins 14, for instance using a ceiling or rack-mounted laser scanner (not shown). A possible example scanner suitable for use for this purpose is the OS32C Safety Laser Scanner offered commercially by OMRON Scientific Technologies, Inc. The plane may be divided in logic of the ECU 40 into a virtual grid, with each segment or pixel of the grid having a corresponding coordinate pair, e.g., XY coordinates in an example XYZ Cartesian frame of reference. Whenever the operator 13 breaks the plane of the light curtain, the coordinates of the location of such breakage of the light beam(s) are detected and transmitted to the ECU 40.

Referring again to FIG. 2, in an optional embodiment the conveyance of information via the light beam LL may be augmented by one or more audio speakers 62, in which case the ECU 40 may be configured to selectively broadcast the information as a voice message 620 within the designated bin aisle 15 of FIGS. 1 and 3 via the speaker(s) 62, e.g., in response to the user request signal CC_{R}. The AOF system 26 may also include a haptic feedback device 64, for instance a wrist band or a badge worn by the operator 13 as shown in FIG. 3. The ECU 40 may be likewise configured to selectively activate the haptic feedback device 64 in response to the user request signal CC_{R}. For example, the haptic feedback device 64 may vibrate when the operator 13 attempts to access an incorrect bin 14. Tactile feedback is immediately perceived by the operator 13 via operation of the haptic feedback device 64, e.g., a small bell and electromagnet assembly.

Referring to FIG. 4, a method 50 for performing the manual picking process 45 of FIG. 3 is shown in accordance with a representative embodiment. The method 50 may be encoded as computer readable instructions that are read and executed by the processor 41 of the ECU 40 shown in FIG. 2. The constituent steps of the method 50 may be programmed into non-volatile components of the memory 43 of the ECU 40, with such steps referred to herein as logic blocks. Each logic block may be executed sequentially by the processor 41 to cause the ECU 40 to perform the described functions.

Beginning with block B52 (“Initiate Picking”), the operator 13 of FIG. 3 may access the HMI 400 of FIG. 2 and initiate the manual picking process 45. The ECU 40 may receive the user input signal CC_{IN} from the HMI 400 as part of this process, with the user input signal CC_{IN} initiating operation of the motorized trolley 30 and the ECU 40. The method 50 thereafter proceeds to block B54.

At block B54 (“Access Pick List”), the ECU 40 next accesses a pick list from its memory 43, either as a previously uploaded pick list or one transmitted in real time from the HMI 400 or another remote device. The method 50 proceeds to block B56 once the pick list has been accessed and read into working memory/RAM.

At block B56 (“Confirmed?”), the ECU 40 next determines if the accessed pick list from block B54 is valid. Block B56 may entail comparing the loaded pick list to a list of authorized pick lists or work orders to ascertain whether the pick list corresponds to a particular picking task for the operator 13. As an example, if the operator 13 is, according to an existing work plan, supposed to pick items to fulfill order A, but instead loads a pick list for order B, the ECU 40 at block B56 may determine that the pick list does not match the current order. In this case, the method 50 proceeds to block B57. The method 50 proceeds to block B58 in the alternative when the pick list from block B54 matches the current work order.

Block B57 (“Register Fault”) entails recording a fault code in memory 43 of the ECU 40, e.g., a binary code, to indicate that the pick list from block B54 does not match a valid work order. The ECU 40 may also illuminate a lamp, display a text message, activate an audible alarm such as a buzzer, trigger the above-noted haptic device 66, or otherwise alert the operator 13 to the error. The method 50 thereafter returns to block B52, with the ECU 40 clearing the error after a predetermined reset interval.

Block B58 (“Detect Tray Position”) entails receiving the three-dimensional (3D) position signals (P₁₈) from the RF transmitter 44 as the tray 18 moves along a designed bin aisle 15 into a designated bin zone, e.g., in conjunction with the operator 13 or in an automated sense such as via a powered alternative to the conveyor 20. In a possible configuration, the ECU 40 receives the 3D position signals P₁₈ using the receiver 45 of FIG. 2, for instance when the RF transmitter 44 is embodied as an ultrasound transmitter.

In other embodiments, the RF transmitter 44 may operate on different principles using other types of non-contact proximity sensors capable of detecting the presence of the tray 18 within a particular bin zone. Non-limiting examples include inductive, capacitive, or photoelectric/optical proximity sensors, in which case the RF transmitter 44 and receiver 45 are configured to operate on the same principle, thus allowing the ECU 40 to detect the tray 18 when the tray 18 enters the designed bin zone. The method 50 proceeds to block B60 once the tray 18 has been detected and its 3D coordinates or other suitable position parameters are ascertained.

At block B60 (“Detect Motor Position”), the ECU 40 communicates with the MCP 39 and/or the encoder 42 of FIG. 3 to determine the current position of the electric motor 45 and the motorized trolley 30. As shown in FIG. 3, the overhead rail 28 extends axially along the bin aisle 15, and thus has a length with corresponding axial positions. The encoder 42 may work in concert with the built-in encoder strips 420 (FIG. 3) to determine and report the current axial position as part of block B60. The method 50 proceeds to block B62 once the ECU 40 has received the current motor position and temporarily recorded the same into non-volatile components of its memory 43.

Continuing with the discussion of FIG. 4, at block B62 (“Tray Position Correct?”) the ECU 40 next identifies a bin zone of the designed bin aisle 15, as an identified bin zone. This action occurs using the 3D position signals P₁₈. A possible approach for performing block B62 includes comparing the current 3D position of the tray 18, i.e., the 3D tray position, to a corresponding boundary of each of the bin zones 14Z of the designed bin aisle 15, with example bin zones 14Z illustrated in FIG. 3. The method 50 proceeds to block B64 when the tray position is correct, and to block B66 in the alternative when the tray position is not in the correct bin zone 14Z for the particular work order or pick list.

Block B64 (“Illuminate Bin(s)”) entails transmitting the lighting control signals CCL to the light projector 33 to cause the light projector 33 of FIGS. 1-3 to illuminate one of more of the storage bins 14 in the identified bin zone(s) 14Z, as the illuminated storage bin(s) 140 of FIG. 3. The illuminated storage bins 140 present information to the operator 13. In a simplified embodiment, the light projector 33 may be commanded to illuminate one or more storage bins 14 in the bin zone 14Z to the exclusion of other storage bins 14. For example, the illuminated storage bins 140 may be illuminated in the sense of directing light of a particular intensity and/or color to indicate that such illuminated storage bins 140 are the only storage bins 14 to be accessed during fulfillment of the pick list/work order.

Information need not be limited to intensity/color. For instance, the light projector 33 may display alphanumeric information such as a number of items from a pick list to be picked up from the illuminated storage bin(s) 140. As noted above, the ECU 40 in one or more optional embodiments may be configured to detect when such items have been picked from the illuminated storage bin(s) 140 using a light curtain, in which case the ECU 40 could decrement the displayed number when an item has been picked from the illuminated storage bin(s) 140.

For example, block B64 may include displaying the numeral “3” on the illuminated storage bin 140, detecting extraction of an item using the light curtain or other suitable detection techniques, and then display the numeral “2”, and so forth until the displayed numeral is “0”, thereafter possibly terminating illumination of the bin 14. Optionally, each respective one of the component storage bins 14 may include a reflective surface portion such as a reflective patch or a painted surface. The ECU 40 may be programmed to identify bins of interest in the identified bin zone 14Z from the pick list, with the bins of interest containing items from the pick list. The ECU 40 thereafter illuminates one or more storage bins 14 in the identified bin zone 14Z with the information by directing the laser beam LL onto the reflective surface portion or painted surface. The method 50 then returns to block B52.

Block B66 (“Adjust Trolley Position”) includes transmitting the position control signals P₃₅ to the motorized trolley 30, in particular to the MCP 39, to command the electric motor 35 to move the motorized trolley 30 to the identified bin zone 14Z corresponding to the tray position from block B58. In response, the motorized trolley 30 translates along the overhead beam 26 to the identified bin zone 14Z. The method 50 proceeds to block B64 once the motorized trolley 30 reaches its commanded destination.

Using the AOF system 26 described above, the operator 13 of FIG. 3 is intuitively guided through the picking process 45 using light-based information, possibly augmented with audible and/or tactile feedback in one or more implementations. In lieu of the operator 13 walking through the various bin aisles 15 of FIG. 1 and examining a paper pick list, for instance, the motorized trolley 30 seamlessly follows the operator 13/tray 18 through the bin aisles 15 using local position tracking and real-time control of the electric motor 35 and light projector 33. The present teachings therefore improve order fulfillment accuracy and speed while reducing ergonomic stress on the operator 13. These and other attendant benefits of the present teachings will be readily appreciated by those skilled in the art in view of the forgoing disclosure.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed is:

1. An automated overhead follower (AOF) system for a manual picking process, the AOF system comprising:
an overhead rail having a longitudinal axis;
a motorized trolley configured to engage the overhead rail and translate along the longitudinal axis in response to position control signals;
a light projector connected to the motorized trolley and configured to emit a light beam in response to lighting control signals;
a radio frequency (RF) transmitter connectable to a tray; and
an electronic control unit (ECU) programmed to:
receive three-dimensional (3D) position signals from the RF transmitter as the tray moves along a designed bin aisle in conjunction with an operator, the 3D position signals being indicative of a 3D tray position;
identify a bin zone of the designed bin aisle, as an identified bin zone, using the 3D tray position;
transmit the position control signals to the motorized trolley to command the motorized trolley to move to the identified bin zone; and
transmit the lighting control signals to the light projector to cause the light projector to illuminate one of more bins in the identified bin zone, as illuminated bins, such that the illuminated bins present information to the operator.

2. The AOF system of claim 1, wherein the RF transmitter includes an ultrasonic transmitter device.

3. The AOF system of claim 1, wherein the ECU is programmed to identify the bin zone by comparing the 3D tray position to a corresponding boundary of each of a plurality of bin zones of the designed bin aisle.

4. The AOF system of claim 1, wherein each respective one of the bins includes a reflective surface portion, and wherein the ECU is programmed to:
identify bins of interest in the identified bin zone from a pick list, the bins of interest containing items from the pick list; and
illuminate the one of more bins in the identified bin zone with the information by directing a light beam onto the reflective surface portion of the bins of interest.

5. The AOF system of claim 1, wherein the information includes a number from the pick list to be picked from the bins of interest.

6. The AOF system of claim 5, wherein the ECU is configured to:
detect when the items from the pick list have been picked from the bins of interest using a light curtain; and
adjust the number when the items from the pick list have been picked from the bins of interest.

7. The AOF system of claim 1, further comprising:
a roller conveyor arranged along the designed bin aisle, wherein the tray is configured to move on a set of rollers of the roller conveyor.

8. The AOF system of claim 1, further comprising:
a speaker, wherein the ECU is configured to selectively broadcast the information as a voice message within the designated bin aisle via the speaker in response to a user request signal.

9. The AOF system of claim 1, further comprising:
a haptic feedback device, wherein the ECU is configured to selectively activate the haptic feedback device in response to a user request signal.

10. The AOF system of claim 1, wherein the overhead rail includes an electric circuit configured to transfer power to the motorized trolley.

11. The AOF system of claim 1, wherein the overhead rail includes a high-speed communication bus.

12. The AOF system of claim 1, wherein the tray includes or is connected to an inductive charger, and wherein the ECU is configured to inductively charge the RF transmitter via the inductive charger.

13. The AOF system of claim 1, wherein the overhead rail includes an encoder strip, and wherein the ECU is configured to determine a linear position of the motorized trolley using the encoder strip.

14. The AOF system of claim 1, further comprising:
a camera connected to the motorized trolley and configured to output image data of the illuminated bins, wherein the ECU is programmed to verify accuracy of the information using the image data.

15. An automated overhead follower (AOF) system for a manual picking process, comprising:
an overhead rail having a longitudinal axis and a high-speed communication bus;
a motorized trolley configured to engage the overhead rail and translate along the longitudinal axis in response to position control signals, wherein the overhead rail includes an electric circuit configured to transfer power to the motorized trolley;
a light projector connected to the motorized trolley and configured to emit a light beam in response to lighting control signals;
an ultrasonic transmitter connectable to a tray;
a roller conveyor arranged along a designed bin aisle, wherein the tray is configured to move on a set of rollers of the roller conveyor; and
an electronic control unit (ECU) programmed to:
receive three-dimensional (3D) position signals from the ultrasonic transmitter as the tray moves along a designed bin aisle in conjunction with an operator, the 3D position signals being indicative of a 3D tray position;
identify a bin zone of the designed bin aisle, as an identified bin zone, using the 3D tray position, by comparing the 3D tray position to a corresponding boundary of each of a plurality of bin zones of the designed bin aisle;
transmit the position control signals to the motorized trolley to command the motorized trolley to move to the identified bin zone; and
transmit the lighting control signals to the light projector to cause the light projector to illuminate one of more bins in the identified bin zone, as illuminated bins, such that the illuminated bins present information to the operator, wherein the information includes a number of the items to be picked from the bins of interest.

16. The AOF system of claim 15, wherein each respective one of the bins includes a reflective surface portion, and wherein the ECU is programmed to:
identify bins of interest in the identified bin zone from a pick list, the bins of interest containing items from the pick list; and
illuminate the one of more bins in the identified bin zone with the information by directing a light beam onto the reflective surface portion of the bins of interest.

17. The AOF system of claim 16, wherein the ECU is configured to:
detect when the items have been picked from the bins of interest using a light curtain; and
adjust the number when the items have been picked from the bins of interest.

18. The AOF system of claim 15, wherein the tray includes an inductive charger, and wherein the ECU is configured to inductively charge the RF transmitter via the inductive charger.

19. The AOF system of claim 15, wherein the overhead rail includes an encoder strip, and wherein the ECU is configured to determine a linear position of the motorized trolley using the encoder strip.

20. A method for performing a manual picking process, comprising:
receiving, via an electronic control unit (ECU), three-dimensional (3D) position signals from a radio frequency (RF) transmitter connected to a tray as the tray is moved along a designed bin aisle, the 3D position signals being indicative of a 3D tray position;
identifying a bin zone of a designed bin aisle using the 3D tray position, as an identified bin zone, the designated bin aisle being one of a plurality of bin aisles;
transmitting position control signals via the ECU to a motorized trolley to command the motorized trolley to move to the identified bin zone along an overhead rail, wherein a light projector is connected to the motorized trolley; and
transmitting lighting control signals via the ECU to the light projector to cause the light projector to illuminate one of more bins in the identified bin zone, as illuminated bins, such that the illuminated bins present information to an operator during the manual picking process.
